(19) United States
(12) Patent Application Publication
(10) Pub. No.: US 2004/0001056 A1
(43) Pub. Date: Jan. 1, 2004

(54) Electrochromic window driver

(75) Inventors: Larry S. Atherton, Anoka, MN (US); James Ingalls, Forest Lake, MN (US); Donald S. Foreman, Fridley, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/185,205

(22) Filed: Jun. 28, 2002

(51) Int. Cl. G09G 5/00

(52) U.S. Cl. 345/212

(57) ABSTRACT

A driver that provides voltage level and polarity select control via a signal to an electrochromic device to vary light transmittance of the device. The driver has a fail-safe feature relative to the electrochromic device if a microcontroller of the driver fails. The driver is sufficiently efficient so as not to necessarily need a heat sink. The driver may sense and measure current and voltage into the electrochromic device.

### BACKGROUND

The invention pertains to controlling the transmission level of an electrochromic window. Particularly, it pertains to drivers that control such window transmission.

Electrochromic technologies, specifically involving inorganic thin film materials, have led to a dimmable window controllable with a low voltage DC source. The glass is essentially a two terminal device which behaves similar to a battery. Applying a voltage to the device can move ions into the electrochromic layer where they will absorb light and dim or “color” the device. The ions can be moved back to the storage layer by reversing the applied voltage and cause the device to lighten or “bleach”. Preferably, devices such as electrochromic windows could use a driver having a variable voltage with polarity reversal to control the light transmittance level of the device, and still have features that prevent the driver from damaging the window in case of driver failure.

### SUMMARY

The present invention is a driver that provides voltage level and polarity for a light transmittance controlling signal to an electrochromic window in an efficient and effective manner. The invention provides for efficient delivery of power to the window to reduce size and eliminate the need for a heat sink. It provides for measurement of current into and voltage across the device. It provides for fail-safe operation in that if the microcontroller fails, the device will not be subject to over-voltage due to such failure.

### BRIEF DESCRIPTION OF THE DRAWING

FIG. 1 is a cross-section view of an electrochromic window;

FIG. 2 is a block diagram of an electrochromic window driver, microcontroller and associated hardware;

FIG. 3 is a diagram of a window driver having a general H-bridge polarity control, and voltage and current sense terminals;

FIG. 4 shows a top or high control driver having an H-bridge configuration;

FIG. 5 is a diagram of a bottom or low side control driver having an H-bridge configuration of switches;

FIG. 6 shows a driver having a direct switch H-bridge configuration;

FIG. 7 is a diagram of a direct control driver having an H-bridge switch;

FIG. 8 reveals a top side control driver and associated circuitry;

FIG. 9 reveals a low side control driver and associated circuitry;

FIG. 10 shows a direct control driver and associated circuitry;

FIG. 11 is a diagram of a microcontroller for use with the drivers;

FIG. 12 shows current sense circuitry;

FIG. 13 shows voltage sense circuitry;

FIG. 14 is a diagram of a programming port for the microcontroller;

FIG. 15 is a diagram of a communications port for the microcontroller; and

FIGS. 16 and 17 are schematics of voltage supplies for a driver.

### DESCRIPTION

Control of an electrochromic window is an example application of the present invention. Electrochromic windows consist of several layers of materials. A coloring function of an example device results from the transport of hydrogen or lithium ions from an ion storage layer and through an ion conduction layer, and injecting them into an electrochromic layer.

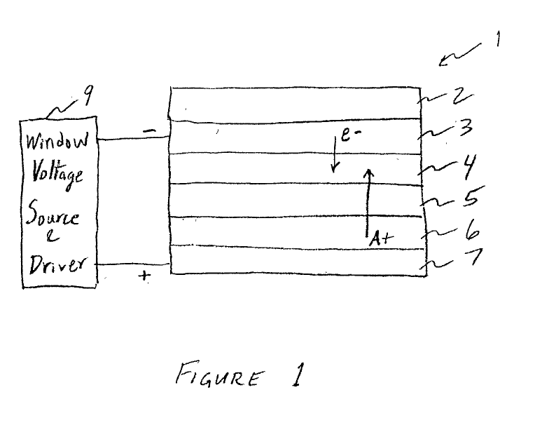

FIG. 1 is an instance of a cross-section of an electrochromic window 1 having variable light transmittance. The layers of window 1 include a glass or plastic substrate 2, a transparent conducting oxide 3, and electrochromic layer 4, an ion conductor/electrolyte 5, an ion storage layer 6, and a transparent conducting oxide 7. Electrochromic layer 4 typically is tungsten oxide (WO₃). The presence of ions in electrochromic layer 4 changes its optical properties, causing it to absorb visible light. The large scale result is that window 1 darkens.

The central three layers 4, 5 and 6 are sandwiched between layers 3 and 7 of transparent conducting material. For the protection of an outside layer 3, window 1 is further covered with layer 2, which may be composed of glass, plastic or some other transparent material. The layers are transparent to visible light.

A negative voltage applied to conducting oxide layer 3 and a positive voltage applied to conducting oxide layer 7, from a voltage source or driver 10, causes hydrogen or lithium ions (A⁺) to be injected from ion storage layer 6 through ion conducting layer 5 into electrochromic layer 4. This application of voltage to layers 3 and 7 causes window 1 to darken (or “color”). To lighten (or “bleach”) window 1, the voltage to layers 3 and 7 is reversed thereby driving the ions in the opposite direction out of electrochromic layer 4 through ion conducting layer 5 into ion storage layer 6. As the ions migrate out of electrochromic layer 4, it lightens (or “bleaches”) and window 1 becomes transparent again.

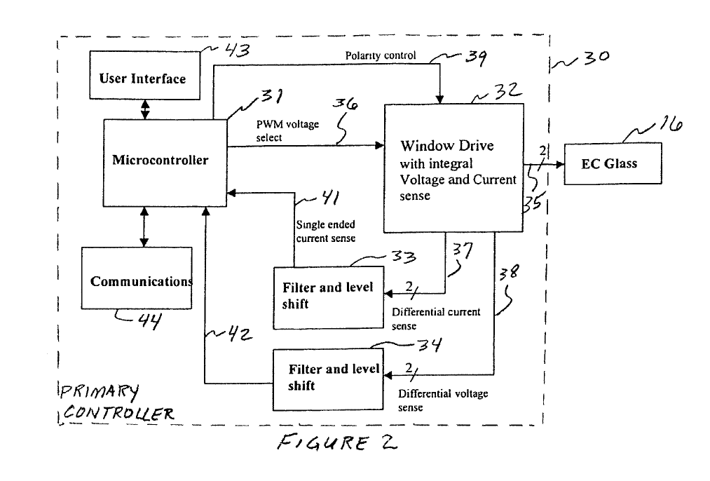

FIG. 2 is a diagram of a platform 30 as an illustrative example incorporating a driver. The circuitry is for driving EC device 16, selecting the polarity of the driving signals to device 16, having the capability to open-circuit device 16 and allowing for measuring the applied current and voltage at the input of device 16. Several goals met with the circuitry include efficient delivery of power to device 16 with minimal size and little or no heat sinking, providing a voltage to device 16 with a range from about −4 to about +4 volts DC at about 0.75 amperes in one illustrative instance, measurement of current and voltage from at least −4 to 4 volts DC, measurement of open-circuit potential of EC device 16, and fail-safe operation which includes protection of device 16 if and when microcontroller 31 fails.

Window drive 32 provides control signals 35 to device 16. Drive 32 takes a voltage and current sense of signals 35 sent to device 16. Microcontroller 31 may provide a pulse width modulated (PWM) voltage select signal 36 to drive 32. Signal 36 can set the magnitude of the voltage signals 35 sent to device 16. Microcontroller 31 also may provide a polarity control signal 39 to drive 32 for setting the polarity of signals 35. Drive 32 provides a differential current sense measurement signal 37 to filter and level shift component 33 and a differential voltage sense measurement signal 38 to filter and level shift component 34. Component 33 may provide a single ended current sense measurement signal 41 and component 34 may provide a voltage sense measurement signal 42 to microcontroller 31. Signals 41 and 42 have information which enables microcontroller 31 to provide an appropriate voltage select signal 36 to drive 32. User interface 43 and communications component 44 can be connected to microcontroller 31 so that an operator may observe information from and control aspects of microcontroller 31 and drive 32.

Window drive 32 arguably has three methods of control. They are regarded as top side, low side and direct controls. Each method has unique requirements for circuitry and power sources. However, the mechanisms for switching polarity and for sensing current and voltage are similar.

The drivers may provide efficient delivery of power to reduce size and possibly eliminate the need for a heat sink. They can provide measurement of current into and voltage across EC device 16. They may allow for the measuring the open-circuit voltage of device 16. The drivers have some fail-safe operation. If microcontroller 31 fails, the driver can protect device 16 from over-voltage conditions.

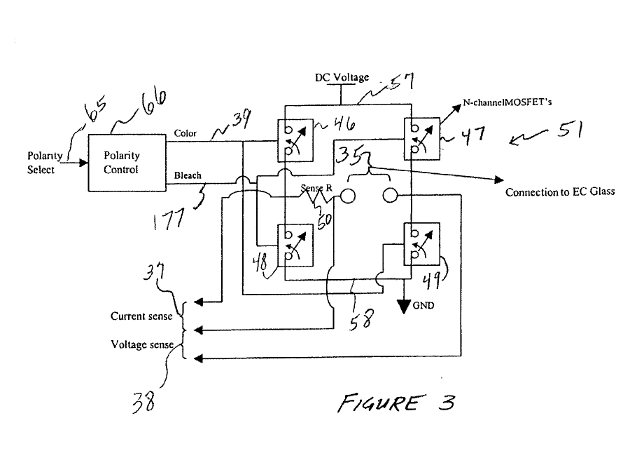

At least one driver illustrated here uses N-channel MOSFET'S 46, 47, 48 and 49 arranged in an H-bridge configuration 51 as shown in FIG. 3. A polarity select signal 65 goes to polarity control component 66 which provides a polarity control signal 39 or 177 to the respective MOSFET gates. Configuration 51 allows for switching polarity on device 16 without the need for a negative power supply. Voltage sense 38 may be a differential measurement across connection 35 to device 16. Current sense 37 can be a differential measurement across a small resistance 50 in series with device 16. This configuration 51 of polarity control and voltage and current sense may be used for the top and low side controls.

FIG. 4 is a block diagram of a top or high control window driver 52. Driver 52 may use an H-bridge configuration 51. A variable DC voltage 53 can be generated to feed top side 57 of H-bridge 51. One approach to generating a variable DC voltage supply 54 is to use a switching power supply using MOSFET's and an LC tank circuit. The DC voltage generated may be proportional to the duty cycle of PWM voltage select signal 36 supplied by microcontroller 31. The power supply requirements may be provided by power supply 55. The requirements could include a 5 volt DC supply for microcontroller 15 and associated circuitry. Vraw of supply 55 may have a large range and provide about 4 volts DC. Vraw may be limited at the high end by the breakdown voltage of the FET's, including FET's 46, 47, 48 and 49, and the circuitry of supply 55 needed to generate voltage Vfet. Supply Vfet may be generated by a single voltage doubler in power supply 55 since the required current is very small. Vfet is generally only used to drive the FET's in H-bridge 51 to guarantee that the FET's stay on regardless of the DC voltage being applied to device 16.

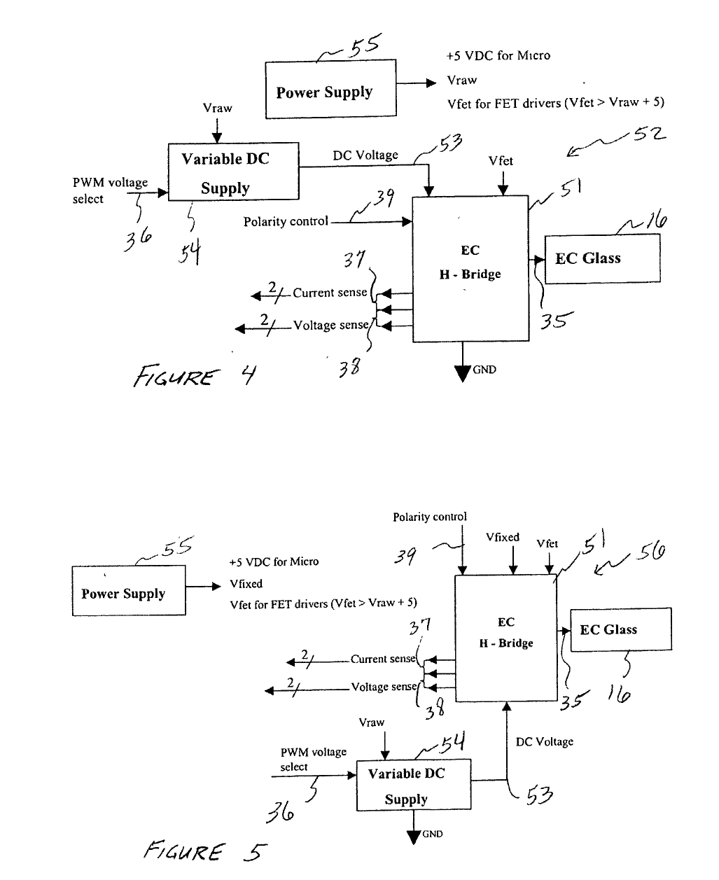

FIG. 5 is a diagram of a bottom or low side control window driver 56. Low side control driver 56 is similar to high side control driver 52 except that variable DC voltage 53 is supplied to bottom side 58 of H-bridge 51 and the voltage across device 16 is the difference between Vfixed and variable DC voltage 53. Another power supply 55 requirement is a Vfixed which is a voltage that has a regulated and stable level but with a limited range.

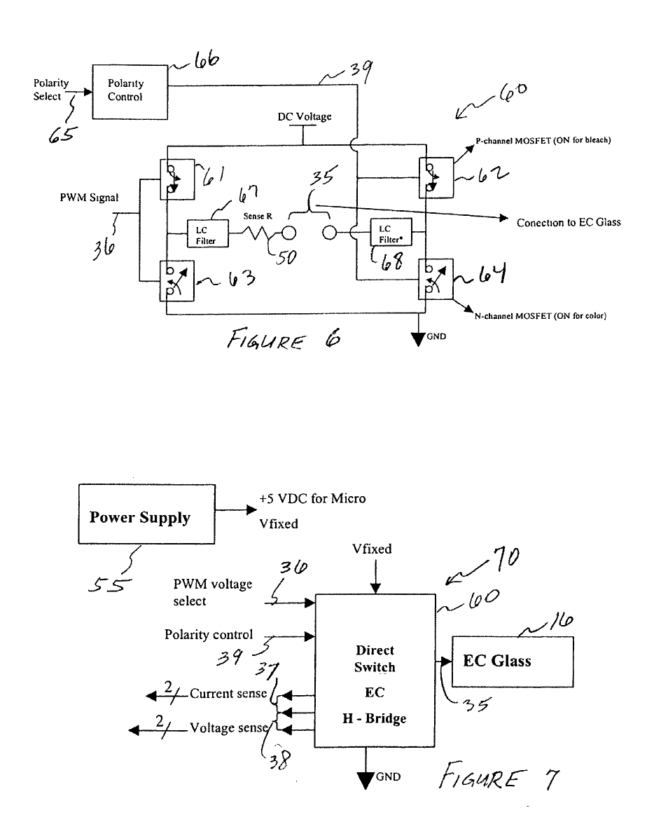

FIG. 6 shows a direct switch H-bridge configuration 60. This H-bridge has P-channel MOSFET's 61 and 62 and N-channel MOSFET's 63 and 64. MOSFET 62 turns on for bleach and MOSFET 64 turns on for color. The variable DC supply is incorporated directly in the H-bridge. FET's 61 and 63 are driven by PWM signal 36 and provide the variable DC voltage supply. FET's 62 and 64 are used for polarity control as noted above. Inductor-capacitor (LC) filters 67 and 68 are used if the DC voltage has too much ripple. Such ripple is not wanted across device 16 when the polarity is changed (i.e., from color to bleach or vice versa). Only one LC filter 67 may be needed.

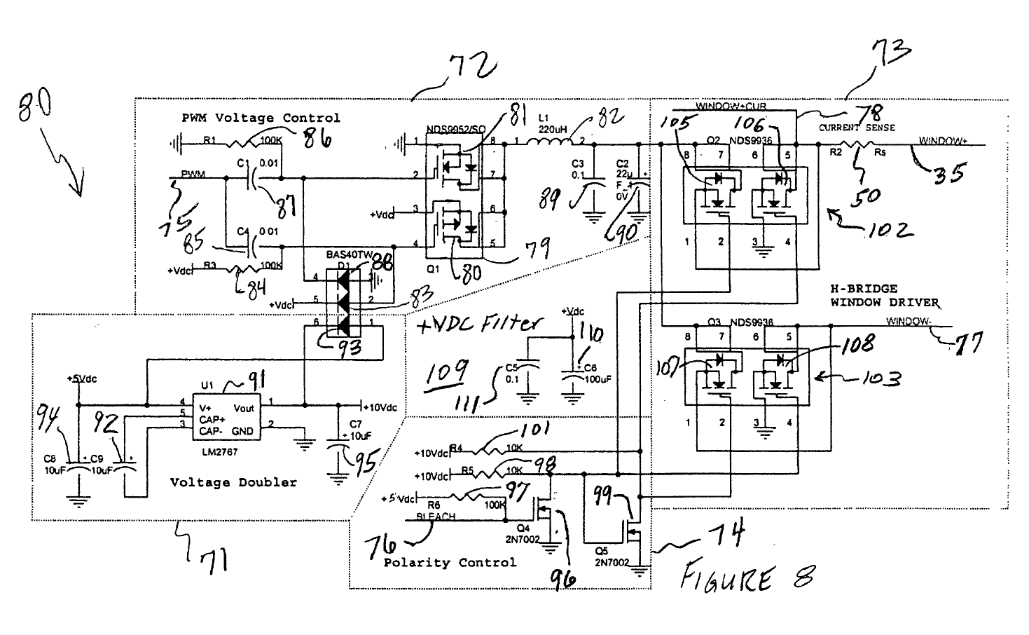

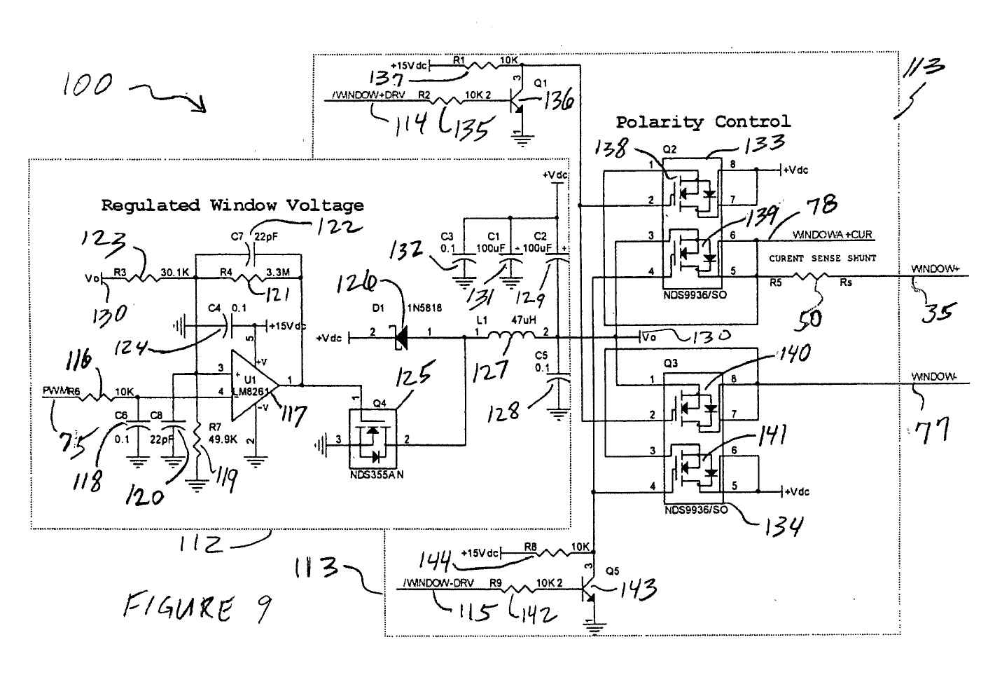

FIG. 7 shows a direct control window driver 70 having direct switch H-bridge 60. Vfixed to circuit 60 may have a larger range with the low side switching but the optional LC filter 68 may be required to keep the ripple low when the polarity is changing.

The following descriptions are more detailed circuit implementations of the EC window drive. The main generality is how to generate the variable DC supply for the top and low side control schemes. FIG. 8 shows an illustrative example of a top side control window drive 80. This drive may have a voltage doubler 71 which provides +10 VDC from a +5 VDC supply. Control 72 is connected to an H-bridge window driver 73. A polarity control circuit 74 is connected to driver 73 and voltage doubler 71. Doubler 71 provides a +10 VDC supply. PWM signal 75 input to control 72 and bleach signal 76 to polarity control 74 are from a microcontroller 31 like that of FIG. 2. Window 16 voltage and current are monitored by voltages measured terminals 35 and 77 and terminals 35 and 78 of resistor 50. After conditioning the window 16 voltage and current signals from terminals 35, 77 and 78, these signals are applied to analog inputs of microcontroller 31.

In PWM voltage control 72, a dual MOSFET 79 has a P-channel FET 80 and an N-channel FET 81. The dual FET 79 is an NDS9952/SO. In FET 80, the source is connected to a +VDC, the drain is connected to the drain of FET 81 and to a 220 microhenry inductor 82, and the gate is connected to the anode of diode 83 and to a 100K ohm resistor 84. The other end of resistor 84 and the cathode of diode 83 are connected to the +VDC. The other end of inductor 82 is connected to a 0.1 microfarad capacitor 89 and a 22 microfarad capacitor 90. The other ends of capacitors 89 and 90 are connected to ground. Also, the gate of FET 80 is connected through a 0.01 microfarad capacitor 85 to the PWM signal 75 line. In FET 81, the source is connected to ground, the drain is connected to the drain of FET 80 which is connected to inductor 82, and the gate is connected to a 100 K ohm resistor 86, a 0.01 microfarad capacitor 87 and the cathode of diode 88. The other end of resistor 86 and the anode of diode 88 are connected to ground. The other end of capacitor 87 is connected to the PWM signal 75 line.

PWM signal 75 charges capacitor 90 through inductor 82 by alternately switching MOSFET's 80 and 81 on and off. MOSFET 80, connected to +VDC, charges capacitor 90 during the low period of PWM signal 75. MOSFET 81 connected to ground discharges capacitor 90 during the high period of PWM signal 75. The voltage on capacitor 90 is proportional to the PWM signal 75 duty cycle, increasing as the PWM signal 75 low period increases to set the desired window 16 voltage. PWM signal 75 is coupled by capacitors 87 and 85 to allow +VDC to be greater than 5 volts. When PWM signal 75 is stopped, both MOSFET's 80 and 81 turn off removing the drive signal on terminals 35 and 77 to window 16. This permits open circuit window 16 voltage measurement for control purposes.

Voltage doubler 71 has a LM2767 switched capacitor charge pump voltage converter integrated circuit 91 which has CAP+ and CAP− terminals connected to both ends of a 10 microfarad capacitor 92, respectively. The +5 VDC supply is connected to the V+ terminal of circuit 91. Also, the V+ terminal is connected to the anode of diode 93 and to one end of a 10 microfarad capacitor 94. The other end of capacitor 94 is connected to ground. The Vout terminal is the +10 VDC supply. The GND terminal of circuit 91 is connected to ground.

Integrated circuit 91 of circuit 71 effectively doubles the +5VDC input. An oscillator, internal to circuit 91, charges capacitor 92 to approximately the voltage at the V+ terminal and then connects capacitor 92 in series with the V+ voltage to the Vout terminal doubling the voltage at the Vout terminal to +10 VDC. The +10 VDC supply is used for MOSFET gate drive of polarity control circuit 74 to assure proper switching of the H-bridge of circuit 73 under all conditions.

In polarity control circuit 74, an N-channel 2N7002 FET 96 has a gate connected to the bleach signal 76 line and to a 100K ohm resistor 97. The other end of resistor 97 is connected to the +5 VDC supply. The drain of FET 96 is connected to a 10K ohm resistor 98. The other end of resistor 98 is connected to the +10 VDC supply. The source of FET 96 is connected to ground. An N-channel 2N7002 FET 99 has a gate connected to the drain of FET 96. The drain of FET 99 is connected to a 10K ohm resistor 101. The other end of resistor 101 is connected the +10 VDC supply. The source of FET 99 is connected to ground.

In H-bridge window driver circuit 73, there are dual MOSFET's 102 and 103, which are NDS9936 integrated circuits. Circuit 102 has N-channel FET's 105 and 106. Circuit 103 has N-channel FET's 107 and 108. The source of FET 105 is connected to line terminal 78. The drain of FET 105 is connected to the non-grounded end of capacitor 90. The gate of FET 105 is connected to the drain of FET 96. The source of FET 106 is connected to ground. The drain of FET 106 is connected to terminal 78. The gate of FET 106 is connected to the drain of FET 99. The source of FET 107 is connected to line 77. The drain of FET 107 is connected to the non-grounded end of capacitor 90. The gate of FET 107 is connected to the drain of FET 99. The source of FET 108 is connected to ground. The drain of FET 108 is connected to line 77. The gate of FET 108 is connected to the drain of FET 96.

Bleach signal 76, along with FET's 96 and 99, controls the H-bridge dual MOSFET's 102 and 103 for a positive (i.e., coloring) or negative (i.e., bleaching) voltage to window 16. When bleach signal 76 is at a logic high, FET 96 is on and MOSFET's 99, 105 and 108 are off. With FET 99 off, MOSFET's 106 and 107 are on. This action connects line 77 to the non-grounded end of capacitor 90 and line 78 to ground to bleach window 16. When bleach signal 76 is at a logic low, FET 96 is off and MOSFET's 99, 105 and 108 are on. This connects line 78 to the ungrounded end of capacitor 90 and line 77 to ground. Window 16 will then be colored.

Filter 109 has a 100 microfarad capacitor 110 and a 0.1 microfarad capacitor 111 connected in parallel with each other. One set of ends of capacitors 110 and 111 is connected to the +VDC supply and the other ends are connected to ground.

FIG. 9 shows an illustrative example of a low side control window drive 100. Drive 100 may include a regulated window voltage circuit 112 and a polarity control circuit 113. A PWM signal 75, “window+drv” signal 114 and window-drv” signal 115 come from microcontroller 31. Signal 75 goes to one end of a 10K ohm resistor 116. The other end of resistor 116 is connected to the inverting input of an LM8261 amplifier 117 and to one end of a 0.1 microfarad capacitor 118. The other end of capacitor 118 is connected to ground. The non-inverting input of amplifier 117 is connected to a 49.9K ohm resistor 119 and a 22 picofarad capacitor 120. The other ends of resistor 119 and capacitor 120 are connected to ground. The output of amplifier 117 is connected to a 3.3 megohm resistor 121 and a 22 picofarad capacitor 122. The other ends of resistor 121 and capacitor 122 are connected to the non-inverting input of amplifier 117 and to a 30.1K ohm resistor 123. The other end of resistor 123 is connected to a Vo voltage supply terminal 130. The V− terminal and V+ terminal of amplifier 117 are connected to ground and a +15VDC supply, respectively. The V+ terminal is also connected to a 0.1 microfarad capacitor 124. The other end of capacitor 124 is connected to ground.

The output of amplifier 117 is connected to the gate of an N-channel NDS355AN MOSFET 125. The source of FET 125 is connected to ground, and the drain of FET 125 is connected to the anode of a 1N5818 Schottky diode 126 and to a 47 microhenry inductor 127. The other end of inductor 127 is connected to one end of a 0.1 microfarad capacitor 128, to one end of a 100 microfarad capacitor 129 and to V0 voltage supply terminal 130. The other end of capacitor 128 is connected to ground. The other end of capacitor 129 is connected to the +VDC supply and to an end of a 100 microfarad capacitor 131 and an end of a 0.1 microfarad capacitor 132. The other ends of capacitors 131 and 132 are connected to ground.

Polarity control 113 has two dual N-channel NDS9936/SO MOSFET's 133 and 134. “Window+drv” signal 114 goes through a 10K ohm resistor 135 to the base of an NPN bipolar junction transistor 136. The emitter of transistor 136 is connected to ground. The collector of transistor 136 is connected to the +15VDC supply via a 10K ohm resistor 137. “Window-drv” signal 115 goes through a 10K ohm resistor 142 to the base of an NPN bipolar junction transistor 143. The emitter of transistor 143 is connected to ground. The collector of transistor 143 is connected to the +15 VDC supply via a 10K ohm resistor 144. Dual MOSFET 133 has a FET 138 and a FET 139, and dual MOSFET 134 has a FET 140 and a FET 141. The source of FET 138 is connected to line 78. The drain of FET 138 is connected to the +VDC supply. The gate of FET 138 is connected to the collector of transistor 136. The source of FET 139 is connected to Vo terminal 130. The drain of FET 139 is connected to line 78. The gate of FET 139 is connected to the collector of transistor 143. The source of FET 140 is connected to Vo terminal 130, and the drain of FET 140 is connected to line 77. The gate of FET 140 is connected to the collector of transistor 136. The source and drain of FET 141 are connected to line 77 and to the +VDC supply, respectively. The gate of FET 141 is connected to the collector of transistor 143.

Window voltage and current are monitored by using the window 16 voltage from lines 35 and 77 and the current signal from line 78. These voltage and current signals are conditioned and then may be applied to analog inputs of a microcontroller 31 or another kind of controller. Regulated window voltage circuit 112 operates as a switching voltage regulator using operational amplifier 117 as a comparator. PWM signal 75 is filtered by resistor 116 and capacitor 118 for a DC voltage level at the inverting input to amplifier 117 proportional to the PWM signal 75 duty cycle. The voltage at the non-inverting input of amplifier 117 is Vo of terminal 130 multiplied by the value of resistor 119 divided by the sum of the values of resistors 119 and 123. When the input voltage to the non-inverting input is higher than the voltage at the inverting input, then the output of amplifier 117 is high, FET 125 is on, and Vo is lowered via inductor 127. When the voltage at the non-inverting input falls below the voltage at the inverting input, then the output of amplifier 117 goes low, FET 125 turns off, and Vo increases. This switching action continues for the regulation of Vo to a level set by the PWM signal 75 duty cycle. Resistor 121 provides hysteresis and sets the Vo ripple. Capacitor 122 may shorten the switching time of operational amplifier 117 to prevent switching losses in FET 125. The window voltage level is from VDC to Vo. For the present application, +VDC may be +8 volts.

Window 16 voltage polarity may be controlled by microcontroller 31 signals “window+drv” 114 and “windowdrv” 115 to polarity control circuit 113. When both signals 114 and 115 are at a logic high, then transistors 136 and 143 are on, the dual N-channel MOSFET's 133 and 134 are off, and there is no voltage drive to window 16. This condition permits open circuit window 16 voltage measurement for control purposes. When signal 114 is at a logic low, then transistor 136 is off, “window+” line 35 is connected to +VDC by FET 138, and “window−” line 77 is connected to Vo terminal 130 by FET 140 to color window 16. When signal 115 is at a logic low, transistor 143 is off, and signal 114 is at a logic high, line 77 is connected to +VDC by FET 141, and line 35 is connected to Vo terminal 130 by FET 139 to bleach window 16. Window drive signals 114 and 115 should not be low at the same time.

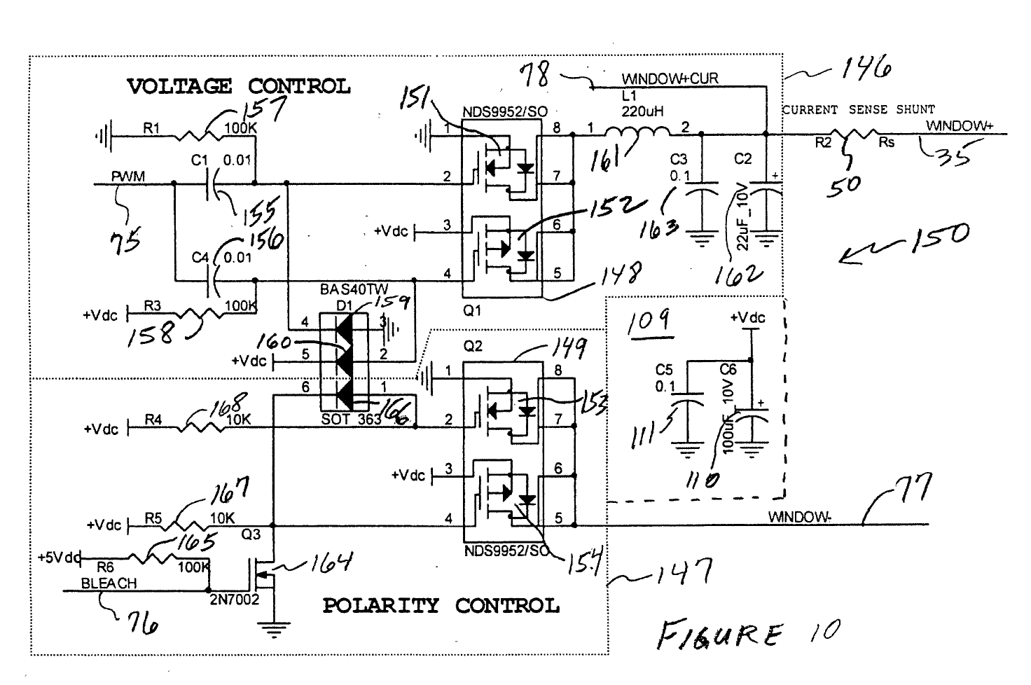

FIG. 10 reveals an illustrative example of a direct control window drive circuit 150, which may include a PWM voltage control circuit 146 and polarity control circuit 147. Circuits 146 and 147 each have a NDS9952/SO dual MOSFET 148 and 149, respectively. Dual MOSFET 148 contains an N-channel FET 151 and a P-channel FET 152. Dual MOSFET 149 contains an N-channel FET 153 and a P-channel FET 154.

The line for PWM signal 75 is connected to an end of a 0.01 microfarad capacitor 155 and an end of a 0.01 microfarad capacitor 156. The other end of capacitor 155 is connected to the gate of FET 151 and the other end of capacitor 156 is connected to the gate of FET 152. A 100K ohm resistor 157 is connected between the gate of FET 151 and ground. A 100K ohm resistor 158 is connected between the gate of FET 152 and a +VDC supply. Also, the gate of FET 151 is connected to the cathode of diode 159, and the gate of FET 152 is connected to the anode of diode 160. The source of FET 151 is connected to ground and the drain of FET 152 is connected to one end of a 220 microhenry inductor 161. The other end of inductor 161 is connected to line 78 and to an end of a 22 microfarad capacitor 162 and an end of a 0.1 microfarad capacitor 163. The other ends of capacitors 162 and 163 are connected to ground. The source of FET 152 is connected to the +VDC supply and the drain of FET 152 is connected to the drain of FET 151. Current sense shunt resistor 50 is connected between lines 78 and 35.

In polarity control circuit 147, a bleach signal 76 goes to the gate of a 2N7002 N-channel MOSFET 164. This gate is connected to one end of a 100K ohm resistor 165. The other end of resistor 165 is connected to a +5 VDC supply. The source of FET 164 is connected to ground. The drain of FET 164 is connected to the cathode of diode 166, to the gate of FET 154 and to one end of a 10K ohm resistor 167. The other end of resistor 167 is connected to the +VDC supply. The source of FET 154 is connected to the +VDC supply. The drain of FET 154 is connected to the drain of FET 153, and to window line 77. The source of FET 153 is connected to ground. The gate of FET 153 is connected to the anode of diode 166 and to one end of a 10K ohm resistor 168. The other end of resistor 168 is connected to the +VDC supply. Filter 109 is described above in the description of window drive 80.

PWM regulated direct control window drive 150 provides a variable DC voltage with polarity reversing for coloring and bleaching electrochromic window 16. PWM signal 75 and bleach signal 76 may be from a microcontroller 31. Window 16 voltage and current are monitored with signals from lines 35, 77 and 78. After these signals are conditioned, they may be applied to the analog inputs of microcontroller 31.

In voltage control block 146, PWM signal 75 charges capacitor 162 through inductor 161 by alternately switching MOSFET's 151 and 152 on and off. FET 152, which is connected to +VDC, charges capacitor 162 during the low period of PWM signal 75 and FET 151 discharges capacitor 162 to ground during the high period of PWM signal 75. The voltage on capacitor 162 is proportional to the PWM signal 75 duty cycle, increasing as the PWM low period increases to set the desired window 16 voltage. “Window+” line 35 via resistor 50 is connected to capacitor 162. PWM signal 75 is coupled by capacitors 155 and 156 to allow +VDC to be greater than 5 volts, and when PWM signal 75 is stopped then FET's 151 and 152 turn off thereby removing the drive signal on line 35 to window 16. At this time, open circuit window 16 voltage can be measured for control purposes.

In polarity control circuit 147, bleach signal 76, FET 164 and dual MOSFET 149 control the polarity of the voltage to window 16. When bleach signal 76 is at a logic low, FET 164 is off and “window−” line 77 is connected to ground. The positive window 16 voltage is between the non-grounded end of capacitor 162 and ground. When bleach signal 76 is at a logic high, FET 164 is on and “window−” line 77 is connected to +VDC. Negative window 16 voltage is between the non-grounded end of capacitor 162 and +VDC. This method of polarity switching requires an inverse PWM signal 75 duty cycle for a negative window 16 drive.

FIG. 11 shows some details of an illustrative example micro-controller 31 that may be utilized in the present invention. Controller 31 may be a PIC16F87.PLCC/PLCC44/SMS/0.875 model. Controller 31 outputs a PWM signal 75 and a bleach signal 76 to a control window 16 drive 80, 100 or 150, as described in FIG. 8, 9 or 10, respectively. Three other signals derived from a control window drive include a “current_sense” signal 201, a window voltage low signal 202 and a window voltage high signal 203.

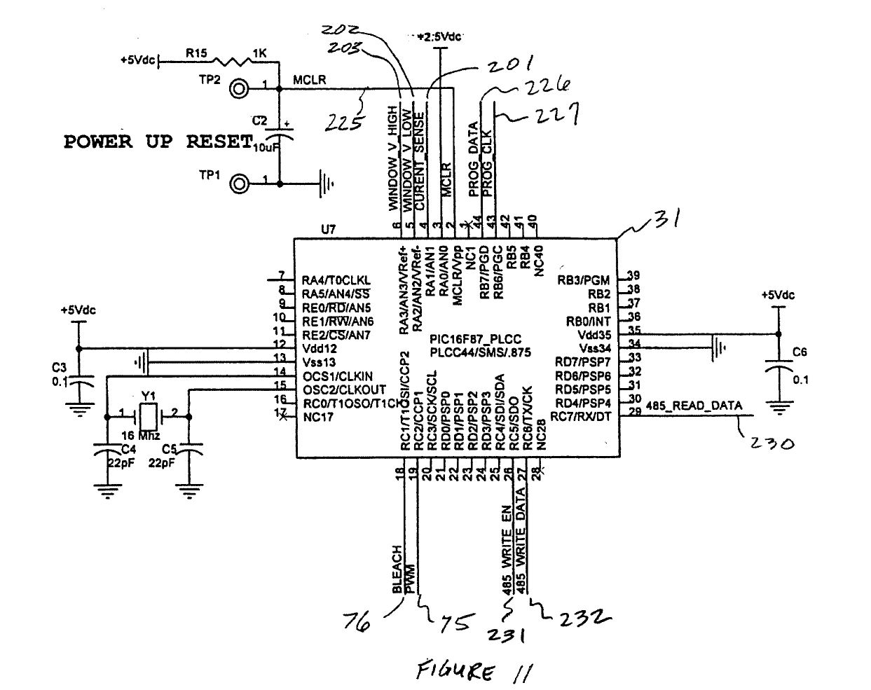

The window current sense circuit 241 of FIG. 12 has an input signal “window+cur” 78 from a control window drive to the non-inverting input of a LMC6484/SO amplifier 206 via a 10K ohm resistor 207. A “window+” signal 35 from a control window drive goes to the inverting input of amplifier 206 via a 10K ohm resistor 208. The output of amplifier 206 is connected to an end of a 66.5K ohm resistor 209 and an end of a 0.1 microfarad capacitor 210. The other ends of resistor 209 and capacitor 210 are connected to the inverting input of amplifier 206. The non-inverting input is connected to an end of a 66.5K ohm resistor 211 and an end of a 0.1 microfarad capacitor 212. The other ends of resistor 211 and capacitor 212 are connected to a +2.5 VDC supply. Output “current_sense” signal 201 may go to an input of a controller 31.

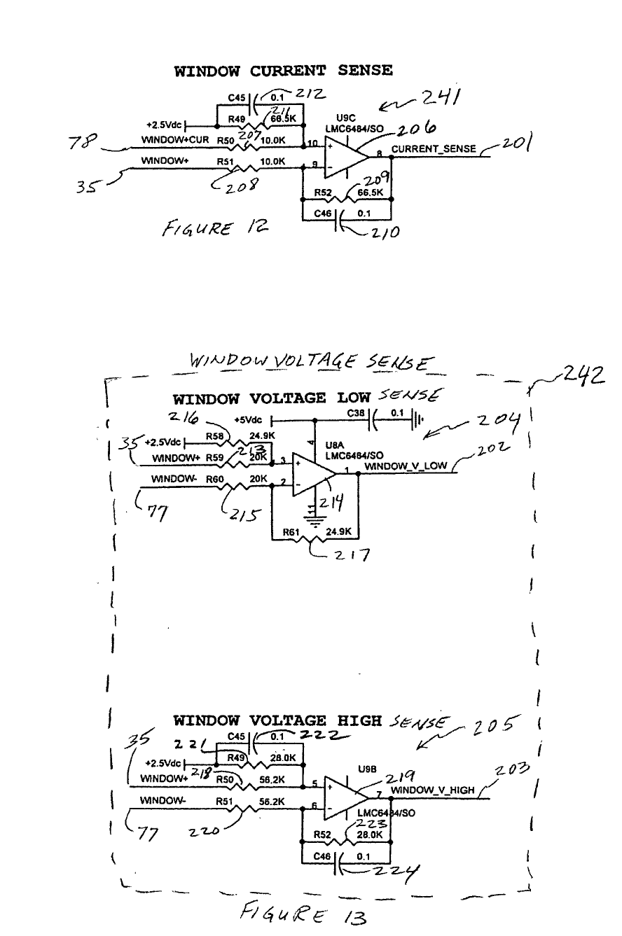

FIG. 13 is a schematic of a window voltage sense circuit 242. Circuit 242 contains a window voltage low sense circuit 204 and a window voltage high sense circuit 205. A “window+” signal 35 goes from a window control drive via a 20K ohm resistor 213 to the non-inverting input of a LMC6484/SO amplifier 214. A “window−” signal 77 goes from a window control drive via a 20K ohm resistor 215 to the inverting input of amplifier 214. The non-inverting input is connected to one end of a 24.9K ohm resistor 216. The other end of resistor 216 is connected to the +2.5 VDC supply. The output of amplifier 214 is connected to one end of a 24.9K ohm resistor 217. The other end of resistor 217 is connected to the inverting input of amplifier 214. The output window voltage low sense signal 202 goes to an input of a controller 31.

Window voltage high sense circuit 205 has a “window+” signal 35 from a window control drive to an end of a 56.2K ohm resistor 218. The other end of resistor 218 is connected to the non-inverting input of an LMC6484/SO amplifier 219. A “window−” signal 77 goes to an end of a 56.2K ohm resistor 220. The other end of resistor 220 is connected to the inverting input of amplifier 219. A 28.0K ohm resistor 221 is connected between the non-inverting input and the +2.5 VDC supply. A 0.1 microfarad capacitor 222 is connected in parallel with resistor 221. A 28.0K resistor 223 connects the output of amplifier 219 with its inverting input. A 0.1 microfarad capacitor 224 is connected in parallel with resistor 223. The output window voltage high sense signal 203 goes to an input of a controller 31.

FIG. 14 shows a programming port 243. It has a master clear connection 225 to a controller 31. There is a program data connection 226 and a program clock connection 227 to a controller 31.

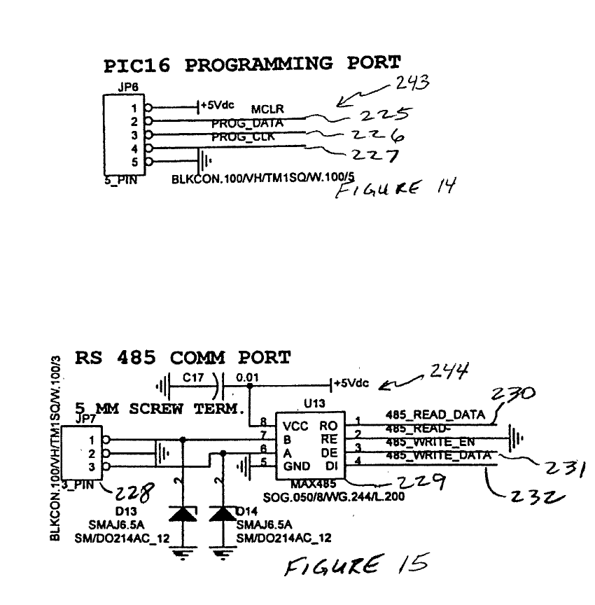

FIG. 15 shows an RS485 communications port 244. It has a three pin terminal 228 connected to a MAX485 interface 229. Interface 229 has a “read_data” connection 230, a “write_en” connection 231 and a “write_data” connection 232 to a controller 31.

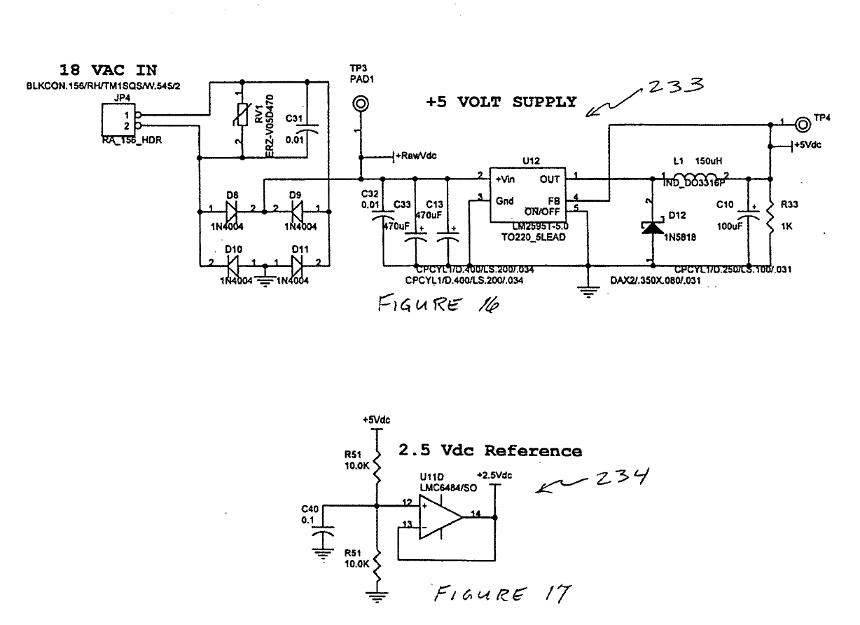

FIG. 16 is a schematic of a voltage supply 233. FIG. 17 is a schematic of a +2.5 VDC reference supply 234. These or comparable voltage supplies may be used in the window control drive system.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. An apparatus for driving an electrochromic device, comprising:
an H bridge switch having a top side and a low side; and
a power supply for supplying a voltage to said H-bridge.

2. The apparatus of claim 1, further comprising a voltage control connected to the low side of said H-bridge switch.

3. The apparatus of claim 1, further comprising a voltage control connected to the high side of said H-bridge switch.

4. An apparatus for driving an electrochromic device, comprising:
an H-bridge switch; and
a voltage control connected directly to the H-bridge.

5. An apparatus for driving an electrochromic device, comprising:
a driver; and
a microcontroller; and
wherein if said microcontroller fails then the output of said driver would not harm the electrochromic device.

6. An apparatus for driving an electrochromic device, comprising:
a first device having first, second and third terminals;
a second device having a first terminal, a second terminal connected to the first terminal of said first device, and a third terminal;
a third device having a first terminal, a second terminal connected to the second terminal of said first device, and a third terminal connected to the third terminal of said second device; and
a fourth device having a first terminal connected to the first terminal of said second device, a second terminal connected to the first terminal of said third device, and a third terminal connected to the third terminal of said first device; and
wherein:
the first and second terminals of said first and fourth devices are disconnected from each other unless a first signal is applied to the third terminal of said first and fourth devices; and
the first and second terminals of said second and third devices are disconnected from each other unless a second signal is applied to the third terminal of said second and third devices.

7. The apparatus of claim 6, further comprising a variable voltage supply having an output connected to the second terminals of said first and third devices.

8. The apparatus of claim 7, further comprising a polarity control having a first output connected to the third terminals of said first and fourth devices, and a second output connected to the third terminals of the second and third devices.

9. The apparatus of claim 8, wherein the first terminal of said first device and the first terminal of said third device are first and second output terminals, respectively.

10. The apparatus of claim 9, wherein the first and second output terminals are for connection to an electrochromic device.

11. The apparatus of claim 6, wherein said first, second, third and fourth devices are N-channel field effect transistors.

12. The apparatus of claim 11, wherein the first terminal, the second terminal and the third terminal of each of said first, second, third and fourth devices are respectively a source, a drain and a gate of a N-channel field effect transistor.

13. The apparatus of claim 6, wherein each device is a relay having the first and second terminals, respectively, and a relay actuator connected to the third terminal.

14. The apparatus of claim 6, wherein the first signal and the second signal may be a positive voltage.

15. The apparatus of claim 6, wherein each said device is an NPN bipolar transistor, having the first terminal as an emitter, the second terminal as a collector and the third terminal as a base.

16. The apparatus of claim 10, wherein:
the first signal is a color signal; and
the second signal is a bleach signal.

17. The apparatus of claim 7, wherein said variable voltage supply outputs a voltage that varies according to a pulse-width-modulated signal to an input of said variable voltage supply.

18. The apparatus of claim 6, further comprising a variable power supply having an output connected to the first terminals of said second and fourth devices.

19. An apparatus for driving an electrochromic device, comprising:
a first device having first, second and third terminals;
a second device having a first terminal, a second terminal connected to the second terminal of said first device, and a third terminal connected to the third terminal of said first device;
a third device having a first terminal connected to the first terminal of said first device, a second terminal and a third terminal; and
a fourth device having a first terminal connected to the first terminal of said second device, a second terminal connected to the second terminal of said third device, and a third terminal connected to the third terminal of said third device; and
wherein:
the first and second terminals of said first and third devices are connected to each other when a first signal is applied to the third terminal; and
the first and second terminals of said second and fourth devices are connected to each other when a second signal is applied to the third terminal.

20. The apparatus of claim 19, wherein:
the first signal may be a negative voltage; and
the second signal may be a positive voltage.

21. The apparatus of claim 19, wherein:
said first and third devices are P-channel field effect transistors; and
said second and fourth devices are N-channel field effect transistors.

22. The apparatus of claim 21, wherein the first, second and third terminals are a source, a drain and a gate, respectively.

23. The apparatus of claim 19, wherein:
said first and third devices are PNP bipolar transistors; and
said second and fourth devices are NPN bipolar transistors.

24. The apparatus of claim 23, wherein the first, second and third terminals are an emitter, a collector and a base, respectively.

25. The apparatus of claim 19, wherein:
the second terminals of said first and second devices are a first output terminal; and
the second terminals of said third and fourth devices are a second output terminal.

26. The apparatus of claim 25, wherein the first and second output terminals are for connection to an electrochromic device.

27. The apparatus of claim 19, wherein each said device is a relay connected to the first and second terminals, respectively, and a relay actuator connected to the third terminal.

28. The apparatus of claim 26, wherein the third terminals of said third and fourth devices are for polarity control.

29. The apparatus of claim 28, wherein the third terminals of said first and second devices are for voltage control.

30. The apparatus of claim 29, wherein the third terminals of said first and second devices may be connected to a pulse-width-modulated signal source.

31. A means for driving an electrochromic device, comprising:
first means for converting a color/bleach select signal into a polarity controlled output to the electrochromic device;
second means for converting a color/bleach magnitude signal into an amplitude controlled output to the electrochromic device; and
third means for preventing damaging signals going to the electrochromic device if said means for driving malfunctions or fails.

32. The means for driving of claim 31, further comprising:
fourth means for sensing current to the electrochromic device; and
fifth means for sensing voltage to the electrochromic device.

33. A method for driving an electrochromic device, comprising:
converting a color/bleach select signal into a polarity controlled output to the electrochromic device; and
converting a color/bleach magnitude signal into an amplitude controlled output to the electrochromic device.

34. The method of claim 33, further comprising:
sensing current at input terminals of the electrochromic device; and
sensing voltage at the input terminals of the electrochromic device.

35. The method of claim 34, further comprising preventing a harmful output from going to the electrochromic device.
